(19) United States
(12) Patent Application Publication
(10) Pub. No.: US 2004/0150983 A1
(43) Pub. Date: Aug. 5, 2004

(54) Greetings Card

(76) Inventors: Conrad Sexton, Allerton (GB); Simon Mallas, Shelf (GB)

Correspondence Address: HEAD, JOHNSON & KACHIGIAN, 228 W 17TH PLACE, TULSA, OK, 74119, US

(21) Appl. No.: 10/717,753

(22) Filed: Nov. 20, 2003

(30) Foreign Application Priority Data
Nov. 20, 2002 (GB) 0227040.3

(51) Int. Cl. F21V 9/16

(52) U.S. Cl. 362/84; 362/99

(57) ABSTRACT

A greetings card comprising at least two panels movable between a closed position wherein the panels are adjacent to each other and an open position wherein the panels are a spaced distance apart. At least one light emitting polymer (LEP) display powered by an electrical supply is provided on the card, the electrical supply typically being controlled by a switch upon manipulation of the card between said open and closed positions and/or by sensing a particular condition with at least one sensor. The illumination of the LEP display typically fades in and/or out in use.

This invention relates to a greetings card.

Conventional greetings cards typically comprise a blank made from sheet material, typically card material, which is folded in half to provide an outer front and back surface and an interior front and back surface. A picture or design is typically provided on the outer front surface and a greeting or message is provided on one of the interior surfaces, which a user is able to read when the card is opened. Such greetings cards typically provide only limited interest to a user and have limited aesthetic appeal.

In an attempt to increase the interest of a greetings card to a user, it is known to provide means for allowing an audio sound, message or tune to be played when the user opens the card. The audio message is played on activation of a switch caused by a user opening the card. Whilst such cards are likely to be of greater interest to a user, they still provide only limited aesthetic appeal. In order to further increase the aesthetic appeal of a greetings card, it is known to provide light emitting diodes (LEDs) therein. However, the LEDs are typically fragile and can be broken easily on delivery of the card in the post or during use of the card. In addition, they allow illumination of only a small surface area of the greetings card and, if a plurality of LEDs are used to illuminate a wider surface area, each LED has to be mounted separately and requires individual wiring, thereby making the end product expensive, time consuming to manufacture and bulky in size.

In order to overcome the problems associated with LEDs, lighting means in the form of electroluminescent displays have been used, such as disclosed in JP2001-188489 and JP2001-100684. The electroluminescent displays are typically in the form of light emitting polymers (LEPs) which are illuminated on application of an electrical charge thereto. However, greetings card incorporating such electroluminescent means are still only of limited interest to a user.

It is therefore an aim of the present invention to provide an improved greetings card which overcomes the abovementioned problems, which has an improved aesthetic appeal to a user and which provides greater interest to the user.

According to a first aspect of the present invention there is provided a greetings card, said greetings card including at least first and second panels, said panels movable between a closed position wherein said panels are adjacent to each other and an open position wherein the panels are a spaced distance apart, said greetings card further including electroluminescent means provided thereon and electronic circuitry associated with said electroluminescent means to generate an electric charge to illuminate said means, characterised in that said circuitry is provided with means to allow the illumination of said electroluminescent means to fade in and/or out of at least one illumination sequence during use.

The ability to allow the electroluminescent means to fade in and/or out of an illumination sequence (typically a pre-determined sequence) greatly increases the aesthetic appearance and appeal of the greetings card to a user. Thus, by gradually increasing the illumination and/or gradually decreasing the illumination of the lighting means from an off condition or from a previous illumination sequence to an on condition or a new illumination sequence, the appearance of the illumination effect can be improved.

The fading in/out can be substantially smooth (i.e. a user is unable to detect any jumps or steps in the increase or decrease in illumination) and/or can take place in a step wise manner. The speed of the fading in/fading out can also be adjusted. For example, fading of the illumination can be rapid or gradual.

In one embodiment programming means are provided to allow the fading in and/or out of the illumination of said electroluminescent means. For example, the programming means can include micro-processing means.

Further preferably timing means can be provided with the electronic circuitry to allow the fading in/fading out of illumination to take place at or for pre-determined time intervals.

Preferably the electroluminescent means are illuminated when the panels of the card are moved between said open and closed positions. Thus, fading in/fading out takes place upon opening or closing of the card.

The electroluminescent means are preferably in the form of light emitting polymers (LEPs) which are illuminated on application of an electrical charge thereto. As such, when the LEPs are illuminated, the greetings card is provided with an improved aesthetic effect which provides greater interest to a person viewing the card. The LEPs are typically provided on sheet material by a printing process which is well known in the art and does not form part of this invention.

The LEPs are provided in the form of a display and the LEP display is illuminated upon activation of an electrical supply thereto.

In one embodiment illumination of the electroluminescent means display is controlled by switch means which is moved between on and off conditions upon manipulation of the card between said open and closed positions.

The open and closed positions which activate/deactivate the switch can be determined by the distance or angle of separation of the panels.

In a further embodiment the electroluminescent means is activated on detection of one of more pre-defined criteria. The pre-defined criteria can include any or any combination of detection of movement, light, sound, temperature and/or the like.

By limiting the activation of the illumination of the electroluminescent means to the occurrence of pre-defined criteria, such as light, temperature, sound and/or movement, the life of the power supply can be extended by preventing illumination in certain conditions. In addition, the requirement for pre-defined criteria to be present can increase the interest of the user in the card. Once the pre-defined criteria has been detected and illumination activated, the illumination can continue for a pre-determined time period or until the pre-defined criteria has been removed.

Preferably movement detection means are provided on the greetings cards for detecting movement of the card, such as for example the card being picked up, and/or movement in the vicinity of the card, such as for example a person walking in front of the card.

Preferably the movement detection means is the form of a movement sensor.

Preferably temperature is detecting by using a temperature sensor on the card.

Further preferably the light detection means is in the form of a light sensor.

Preferably the sound detection means is in the form of an audio sensor. For example, if a user whistles or makes a noise in the vicinity of the sensor, the electroluminescent means on the greetings card can be activated and illuminated.

Preferably the electroluminescent means is located in or adjacent at least one aperture defined in the card, thereby allowing illumination of the electroluminescent means to be visible through the aperture. Alternatively, or in addition to, the electroluminescent means can be located on a surface of the card.

The at least one aperture can be provided in a required design or shape and the electroluminescent means can either be provided of such dimensions so as to overlap the edges defining the aperture or the electroluminescent means can be provided of a required design or shape which is visible through the aperture. In whichever embodiment used, the resulting effect is that the LEP typically illuminates a particular design or shape when activated.

In one embodiment the electroluminescent means can be provided on both first and second panels of the sheet material and/or first and second surfaces of a panel, thereby for example allowing illumination of the electroluminescent means to be visible from the front of the card and when the user is viewing the interior of the card.

Preferably the at least two panels are formed from a blank and are defined by fold lines, the fold lines allowing movement of the panels thereabout. However, the card can be formed from separate panels joined together by adhesive or other conventional means.

Preferably a further panel is provided which is located over the electrical circuitry to hide the same from view. The further panel is typically secured to the at least first or second panels by securing means.

The securing means can include any or any combination of adhesive, clips, staples and/or the like.

Preferably the electrical circuitry includes at least an electrical power supply, such as a battery, electrical connections, such as wiring loom, an invertor and switch means to allow illumination of the LEP to be activated/inactivated.

In one embodiment the invertor or sequencing means can be used to allow the electroluminescent means to be illuminated in a pre-determined sequence. For example, the electroluminescent means can be made to flash on and/off at pre-determined time intervals, fade and/or the like.

The invertor can be a wire wound invertor or chip wound invertor but the latter is most preferable due to the small dimensions of the same.

In a further embodiment a frequency adaptor is provided for use with illuminating the LEPs. By adjusting the frequency at which the LEPs are switched on/off, the colour of the LEPs can be adjusted accordingly. Thus, a variety of different colours can be provided without the requirement for separate coloured LED bulbs to be used, as would be the case with conventional greetings cards.

If two or more LEP displays are provided, a plurality of switches can be provided to control illumination of the same. However, any combination of numbers of LEP displays or switches can be provided. Alternatively, or in addition to, a double switch can be provided to allow activation of one or more of the displays and deactivation of others when first pre-defined criteria are met, and vice versa depending on the operational conditions of the switches.

In one embodiment, a first switch is provided to activate the LEP when the panels are moved a first pre-determined distance or angle apart. Activation of the LEP typically moves the LEP into a first condition. A second switch is activated when the panels are moved to a second pre-determined distance or angle apart. Activation of the second switch typically causes a change in condition of the LEP or further LEPs.

Preferably the blank is formed from a sheet material, such as card stock.

Preferably the LEP and electrical components allowing illumination of the LEP can be formed as a single unit for location in/on the greetings card/blank. The single unit can then be connected to a power supply before location with the greetings card or after location therewith.

According to a second aspect of the present invention there is provided a greetings card, said greetings card including electroluminescent means provided thereon and electronic circuitry associated with said electroluminescent means to generate an electric charge for illumination of said means, characterised in that said electronic circuitry includes detection means for detection of one or more pre-defined criteria and, upon detection of said pre-defined criteria an electric charge is provided to said electroluminescent means to cause illumination thereof.

Preferably the pre-defined criteria includes any or any combination of light, sound and/or detection of movement in the locality of the greetings card.

The advantages of the present invention are that an LEP display is lighter in weight than conventional LEDs. The LEP display can be printed easily onto the greetings card, thereby reducing the time and cost of manufacturing the card. In addition, LEPs can be used to create a greater range of designs due to the larger surface area that can be illuminated and the ease with which the colour of the illuminated display can be changed.

Embodiments of the present invention will now be described with reference to the accompanying figures wherein:

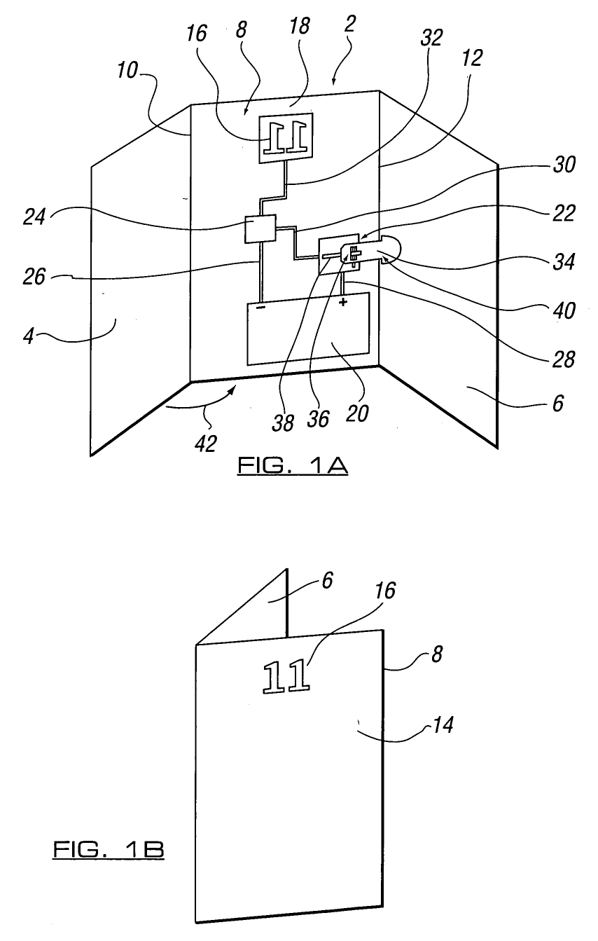

FIGS. 1a and 1b illustrate a greetings card according to an embodiment of the present invention;

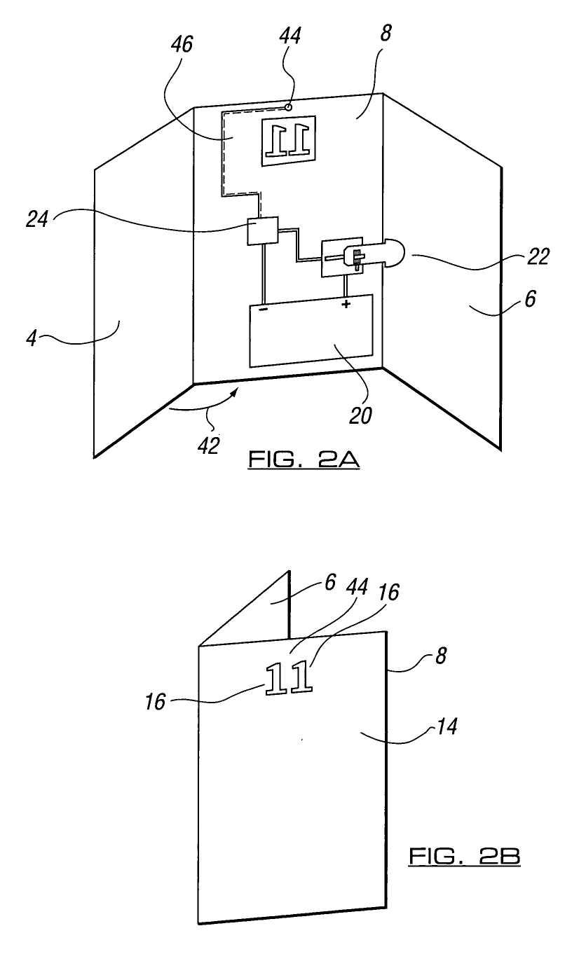

FIGS. 2a and 2b illustrate a greetings card according to an embodiment of the present invention in which a motion sensor is provided;

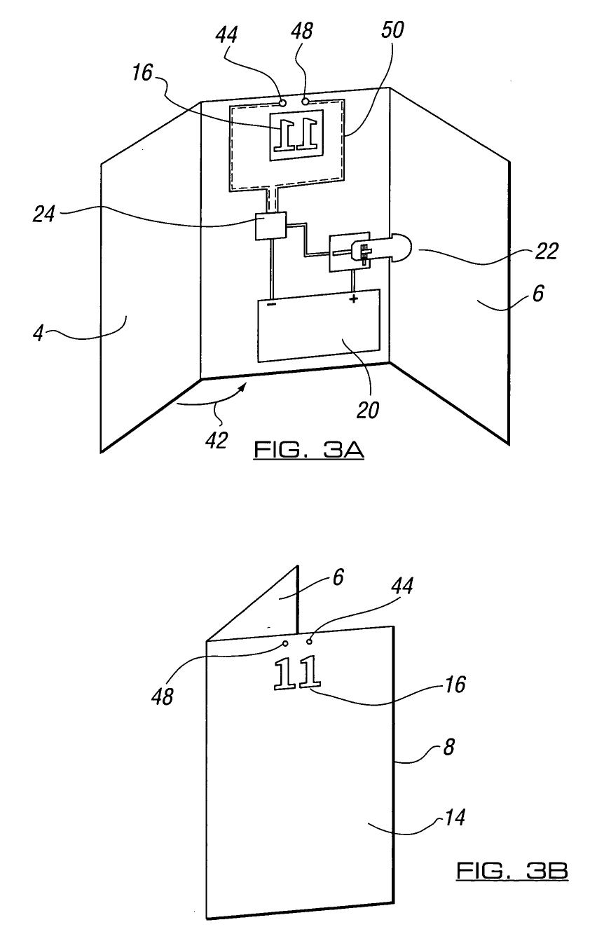

FIGS. 3a and 3b illustrate a greetings card according to an embodiment of the present invention in which a motion sensor and a light sensor are provided; and

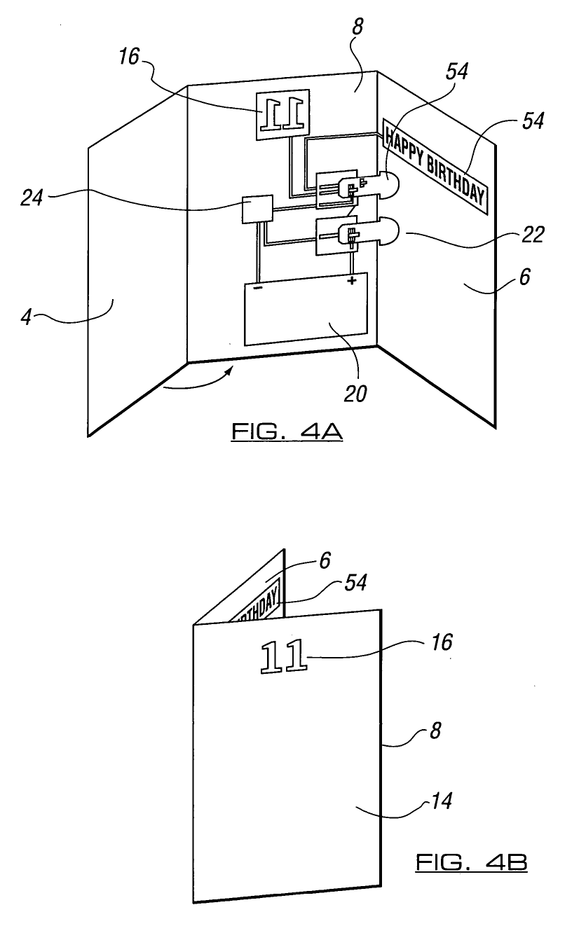

FIGS. 4a and 4b illustrate a greetings card according to a further embodiment of the present invention.

Referring to FIGS. 1a and 1b, there is illustrated a greetings card 2 in the form of a blank made from sheet card material. The blank comprises end panels 4 and 6 and a middle panel 8. The panels 4, 6 and 8 are defined by fold lines 10 and 12.

When the card is formed, the front of the greetings card is provided by front surface 14 of middle panel 8, as shown in FIG. 1b. An aperture is defined in the front panel 8 and an LEP element 16 is located therein in a required design. In this example, the LEP element is in the form of a number to represent the age of a person to whom the greetings card is to be given.

The back surface 18 of the middle panel 8 is provided with power means in the form of a battery 20, a switch mechanism 22, an invertor or flasher unit 24 and connections 26, 28, 30 and 32 therebetween. These electrical components are typically formed as a single unit prior to location on the greetings card.

The battery 20 provides electrical charge for activating the LEP display element and causing the same to luminesce. The switch mechanism 22 comprises a sliding arm 34, which has a first end 36 attached to the switch 38 and a second end 40 attached to panel 6. A pair of conductive areas (not shown) are provided in the switch and the sliding arm 34 acts as a conductive shorting member. When panel 6 is moved in a direction away from middle panel 8, sliding arm 34 moves to a position wherein the sliding arm 34 contacts the conductive areas to complete the circuit, thereby moving the switch to an on condition and allowing illumination of the LEP display. When panel 6 is moved in a direction towards middle panel 8, sliding arm 34 moves to a position wherein the sliding arm is out of contact with the conductive areas, thereby moving the switch to an off condition such that the LEP is no longer illuminated.

In accordance with one aspect of the present invention, when the switch has been activated, illumination of the LEP element is caused to fade in from an off condition to a fully lit condition. Conversely, when the switch has been moved to an off condition, illumination of the LEP element is caused to fade out from a fully lit condition. This greatly improves the aesthetic effect provided by the card.

It will appreciated by persons skilled in the art that the fading in/fading out can also take place from a previous illumination sequence.

The battery 20 is connected to invertor 24 via connection 26 and allows illumination of the LEP element 16 according to a pre-determined sequence, such as flashing of the LEP element. The invertor also controls the fading in/fading out of the illumination of the LEP element. However, it is noted that the invertor is not necessarily required and a continuous electrical charge can be provided from the battery to the LEP element 16 to illuminate the LEP continuously when the switch is in an on condition. The fading in/fading out can also be undertaken by processing means, such as via a micro-processing chip.

The connections 26, 28, 30, 32, switch mechanism 22, invertor 24 and battery 20 are typically of such dimensions that they do not substantially protrude from the surface of middle panel 8. When the card is constructed, end panel 4 is folded along fold line 10 and moved to a position adjacent back surface 18 of the middle panel, as shown by arrow 42. The end panel 4 is then adhered to middle panel 8 to maintain the same in position and to hide the electrical connections.

Thus, when constructed the end panel 6 forms the back of the greetings card and middle panel 8 forms the front of the greetings card. When the card is opened and the switch is moved to an on condition, the LEP element 16 is illuminated. When the card is closed, the switch is moved to an off condition and the LEP is not illuminated.

There is typically a pre-determined point or angle of separation of end panel 6 from middle panel 8 at which the switch is moved from the on condition to the off condition. The point is determined by the manufacturer but is typically provided to allow the LEP element to illuminate when the card is located in an upright and partially open position, as shown in FIG. 1b. Alternatively, operation of the switch may be allowed only when the card is in a fully open position.

Referring to FIGS. 2a and 2b, a similar greetings card arrangement is provided to that in FIGS. 1a and 1b. In this embodiment a motion sensor 44 is provided on panel 8. Any movement in the vicinity of the greetings card is detected by motion sensor 44 and this activates the LEP to illuminate, irrespective of the switch/sliding arm position. As such, any person approaching the card or walking past the card will activate illumination of the LEP.

The motion sensor 44 is typically connected to invertor 24 by connection 46.

In a further embodiment, as shown in FIGS. 3a and 3b, a light sensor 48 is provided in addition to, or as an alternative to motion sensor 44. Since the LEP may not be visible in bright sunlight and will be most effective when there is little or no sunlight, such as at night time or in a low lit room, the light sensor activates LEP illumination when a pre-determined light level is detected.

The light sensor is typically connected to invertor 24 via connection 50. The light sensor can work in combination with motion sensor 44, such that the LEP is illuminated only when motion is detected in the vicinity of the card and a pre-determined light level is detected. Thus, in addition to being able to activate LEP illumination by opening the card to a substantially fully open position, the LEP is activated typically in a low lit or dark room when motion, such as a person walking past the card, is detected.

FIGS. 4a and 4b illustrate a yet further embodiment of the present invention in which a further switch mechanism 52 is provided. This additional switch mechanism 52 is used to activate a further LEP element 54 provided in a required design, which in this example is a “Happy Birthday” message, on the inside surface of the card on end panel 6.

The switch mechanism 52 is in the form of a double switch which is able to activate LEP elements 16 and 54 in combination or can be used to divert electrical power from the external LEP element 16 to the internal LEP element 54. When the greetings card is opened, the switch 22 operates in the normal manner. If the greetings card is opened beyond a certain pre-defined angle, for example 100 degrees, the second double switch 52 breaks the circuit to the external display LEP element 16 and completes the circuit to the internal display LEP element 54, thereby illuminating the same. Thus, the required LEP element can be illuminated depending on whether the user is viewing the exterior of the card or the interior of the card.

It will be appreciated by persons skilled in the art that manual activation of the switch to result in illumination of the LEP display(s) can be provided at any time.

Thus it can be seen that the present invention provides a greetings card with improved aesthetic appeal which is likely to provide greater interest to the user.

1. A greetings card, said greetings card including at least first and second panels, said panels movable between a closed position wherein said panels are adjacent to each other and an open position wherein the panels are a spaced distance apart, said greetings card further including electroluminescent means provided thereon and electronic circuitry associated with said electroluminescent means to generate an electric charge to illuminate said means, characterised in that said circuitry is provided with means to allow the illumination of said electroluminescent means to fade in and/or out of at least one illumination sequence during use.

2. A greetings card according to claim 1 characterised in that illumination of the electroluminescent means fades in from an off condition or from a previous illumination sequence to an on condition.

3. A greetings card according to claim 1 characterised in that the fading in and/or out of the illumination sequence is undertaken in a substantially smooth manner.

4. A greetings card according to claim 1 characterised in that the fading in and/or out of the illumination sequence is undertaken in a step wise manner.

5. A greetings card according to claim 1 characterised in that the electronic circuitry includes programming means for programming said fading in/fading out.

6. A greetings card according to claim 1 characterised in that the electronic circuitry includes an inverter to allow said illumination to fade in and/or out.

7. A greetings card according to claim 1 characterised in that the electronic circuitry includes timer means to allow the fading in and/or fading out of the illumination to be undertaken at or for pre-determined time intervals.

8. A greetings card according to claim 1 characterised in that said electroluminescent means are in the form of light emitting polymers (LEPs).

9. A greetings card according to claim 1 characterised in that the electronic circuitry includes at least an electrical power supply, switch means for switching the power supply to said electroluminescent means between on and off conditions and electrical connections connecting the power supply, switch means and electroluminescent means together.

10. A greetings card according to claim 1 characterised in that the switch means is moved between said on and off conditions on moving the first and second panels between said open and closed positions respectively.

11. A greetings card according to claim 1 characterised in that the switch is moved between said on and off conditions when the first and second panels are moved pre-determined distances apart.

12. A greetings card according to claim 1 characterised in that a further panel is located over said electrical circuitry to substantially hide said electronic circuitry from view.

13. A greetings card according to claim 12 characterised in that the further panel is secured to the at least first or second panels by any or any combination of adhesive, one or more clips or staples.

14. A greetings card according to claim 1 characterised in that the electroluminescent means are illuminated upon detection of one or more pre-defined criteria using detection means.

15. A greetings card according to claim 14 characterised in that the pre-defined criteria includes any or any combination of movement, light, sound or temperature in the locality of the card.

16. A greetings card according to claim 14 characterised in that the detection means includes a movement sensor.

17. A greetings card according to claim 14 characterised in that the detection means is a light sensor.

18. A greetings card according to claim 14 characterised in that the detection means is an audio sensor.

19. A greetings card according to claim 14 characterised in that the detection means is a temperature sensor.

20. A greetings card according to claim 1 characterised in that said electronic circuitry includes sequencing means.

21. A greetings card according to claim 20 characterised in that said sequencing means is a chip wound invertor.

22. A greetings card according to claim 20 characterised in that said sequencing means is a wire wound invertor.

23. A greetings card according to claim 20 characterised in that said sequencing means allows illumination of said electroluminescent means in a pre-determined sequence.

24. A greetings card according to claim 23 characterised in that said predetermined sequence includes flashing of said illumination display provided by said electroluminescent means between on and off conditions.

25. A greetings card according to claim 24 characterised in that frequency adaption means are provided with said electronic circuitry for adjusting the frequency at which said electroluminescent means are switched between said on and off conditions.

26. A greetings card according to claim 25 characterised in that the colour of said electroluminescent means can be changed by adjusting said frequency.

27. A greetings card according to claim 1 characterised in that the electronic circuitry includes two or more switch means for switching the illumination of the electroluminescent means between on and off conditions.

28. A greetings card according to claim 8 characterised in that two or more LEP displays are provided on the card.

29. A greetings card, said greetings card including electroluminescent means provided thereon and electronic circuitry associated with said electroluminescent means to generate an electric charge for illumination of said means, characterised in that said electronic circuitry includes detection means for detection of one or more pre-defined criteria and, upon detection of said pre-defined criteria an electric charge is provided to said electroluminescent means to cause illumination thereof.
